(19) United States
(12) Patent Application Publication
(10) Pub. No.: US 2009/0263079 A1
(43) Pub. Date: Oct. 22, 2009

(54) OPTICAL ROUTERS AND LOGICAL GATES BASED ON THE PROPAGATION OF BRAGG SOLITONS IN NON-UNIFORM ONE-DIMENSIONAL PHOTONIC CRYSTALS

(76) Inventors: Yuval Shapira, Timrat (IL); Amir Rosenthal, Haifa (IL); Moshe Horowitz, Haifa (IL)

Correspondence Address: The Law Office of Michael E. Kondoudis, 888 16th Street, N.W., Suite 800, Washington, DC, 20006, US

(21) Appl. No.: 12/350,269

(22) Filed: Jan. 8, 2009

Related U.S. Application Data
(60) Provisional application No. 61/019,673, filed on Jan. 8, 2008.
(60) Provisional application No. 61/031,873, filed on Feb. 27, 2008.

(51) Int. Cl. G02B 6/26; G02B 6/34

(52) U.S. Cl. 385/16; 385/37

(57) ABSTRACT

An optical router for all-optical control over the propagation direction of optical pulses, comprising: (i) a non-uniform one-dimensional photonic crystal receiving a plurality of input optical pulses, comprising: at least one first region used to obtain Bragg solitons; at least one second region in which non-linear interaction between two sufficiently adjacent solitons is obtained; and at least one third region used to de-couple resulting after the interaction pulses outside the one-dimensional photonic crystal's grating; and (ii) a plurality of sufficiently temporally separated optical pulses launched towards said one-dimensional photonic crystal from either of its sides, such that the number of pulses de-coupled from at least one of the sides of the grating is different in case when interaction between the pulses occurs inside the grating, from the case when no interaction between pulse occurs inside the grating.

### TECHNICAL FIELD

The present invention relates to logical gates and routers, and more particularly to optical logical gates and routers based on the propagation of Bragg solitons in a one-dimensional photonic crystal.

### BACKGROUND ART

A logic gate performs a logical operation on one or more logic inputs and produces a single logic output. Because the output is also a logic-level value, an output of one logic gate can connect to the input of one or more other logic gates. The logic normally performed is Boolean logic and is most commonly found in digital circuits. Logic gates are primarily implemented electronically using diodes or transistors, but can also be constructed using electromagnetic relays, fluidics, optics, or even mechanical elements.

A router is a device that forwards information along networks A router has at least one input signal terminal and at least two output signal terminals. In addition, the router also has a control signal terminal. According to the control signal through the control terminal the router directs or routes the signal at the input terminal to one of the output terminals. Routers are often electronic devices that are common in telephony networks and computer networks, though routers can also be mechanical or optical devices. Sometimes routers can also be software in a computer.

A photonic crystal is an optical medium that has a periodic or quasi-periodic structure of the refractive index. When the photonic crystal is periodic only in one direction, it is referred to as a one-dimensional photonic crystal. Such one-dimensional (1D) crystal is often referred to as grating. One important family of such gratings is the fiber Bragg gratings (FBG): it is an optical fiber in which the core refractive index is modulated by a periodic function. The FBGs are usually realized by side illumination of the optical fiber by intense ultra-violet (UV) light. Gratings are characterized by modulation depth of the refractive index, by the periodicity step Λ, and by the average refractive index ⁿ_{ef f} over one period of the grating. When light enters the grating, the phase and the amplitude of the reflected or transferred light greatly depend on the wavelength of the incident light, λ. The wavelength discrepancy or dispersion of the grating is strongest when λ≈2n_{ef f}Λ=Λ_{B}. Λ_{B} is called “Bragg wavelength” and when the wavelength of the incident light is close to the Bragg wavelength, most of the light is reflected from the grating. The high reflectivity region in the wavelength domain is called “photonic bandgap”.

Most fiber Bragg gratings are used in single-mode fibers. Telecom applications of FBGs often involve wavelength filtering, e.g. for combining or separating multiple wavelength channels in wavelength division multiplexing systems (optical add-drop multiplexers). Extremely narrow-band filters can be realized e.g. with rather long FBGs (having a length of tens of centimeters) or with combinations of such grating.

FBGs can be used as end mirrors of fiber lasers (distributed Bragg reflector lasers, DBR fiber lasers), then typically restricting the emission to a very narrow spectral range. Even a single-frequency operation can be achieved e.g. by having the whole laser resonator formed by a FBG with a phase shift in the middle (distributed feedback lasers). Outside a laser resonator, an FBG can serve as a wavelength reference e.g. for stabilization of the laser wavelength. This method can also be applied for wavelength-stabilized laser diodes.

In some fibers, there can be a significant deviation between the Bragg wavelengths for different polarization directions (i.e., a birefringence). This may be used e.g. for fabricating rocking filters.

Bragg solitons is a general term that refers to intense optical pulses (beams) that propagate inside the photonic crystals, in which the strong dispersion (diffraction) associated with the photonic crystals' bandgap that would in linear regime broaden the pulses (beams) along their propagation, is compensated by non-linear effects such as Kerr non-linearity resulting in pulses (beams) with constant intensity characteristics that can propagate long distances without broadening. In the scope of this application, the term Bragg soliton specifically refers to strong optical pulses, which central frequency is close to the Bragg wavelength (or the average Bragg wavelength in case of quasi-periodic structures) and may even be located inside the photonic bandgap, which intensity profile is not significantly damaged during the propagation along the photonic crystal, due to the delicate balance between the linear and non-linear effects cts, and that at least at some sections along the photonic crystal propagate with group velocity that is much lower than the speed of light.

Optical logic devices in fibers can increase the speed of data processing beyond the speed obtained in similar electronic systems. Devices based on soliton interaction are attractive since the pulses at the output of the device remain solitons. Hence, several devices can be cascaded in order to obtain complex operation. In devices based on soliton interaction, the direction of propagation of intense optical pulses can be optically controlled. The new ways of routing of optical pulses are important for applications that involve high- and mid-power pulses, such as optical metrology, second and third harmonic generation, parametric amplification and Raman amplification.

Optical gating based on soliton-dragging effect has been previously demonstrated and analyzed [1], [2]. Due to the low group velocity dispersion in fibers, the typical device length is on the order of tens of meters.

Bragg or “gap” solitons can propagate along fiber Bragg gratings (FBGs)[3], and their central frequency may be located within or close to the grating bandgap. Recently, the propagation of a Bragg soliton with a velocity significantly lower than the speed of light in the fiber was demonstrated using relatively low power pulses [10]. Due to the high dispersion that can be obtained in gratings, a significant interaction between Bragg solitons can be obtained on length scales of centimeters, more than five orders of magnitude shorter than required in standard fibers [3]. In a previous work, self optical switching in FBGs based on soliton formation has been demonstrated [4].

An optical AND gate based on interaction between two coupled orthogonally polarized solitons in birefringent FBG has been demonstrated theoretically and experimentally [5, 6]. The device requires that two pulses will overlap during the propagation in the device, that is, two orthogonally polarized pulses will be launched at the same time in order to form a coupled gap soliton with about twice the power of a single soliton. The high power of the coupled gap soliton shifts away the bandgap due to Kerr effect and allows the soliton to be transmitted through the device. An interaction between pulses in FBGs has been also used in previous work to theoretically demonstrate an efficient gap soliton formation [7]. The interaction enabled to transmit a single soliton even when multiple pulses were formed due to modulation instability effect.

### SUMMARY OF INVENTION

It is an object of the present invention to use interaction between two gap solitons in a one-dimensional photonic crystal in order to perform optical routing of optical pulses and to perform optical logical operations.

It is another object of the present invention to use interaction between two gap solitons in a one-dimensional photonic crystal in order to perform optical logical operations.

It is a further object of the present invention to use interaction between two gap solitons in a one-dimensional photonic crystal in order to obtain logical gates.

Interaction between Bragg solitons with the same polarization changes the frequencies of the interacting solitons. Similar effect occurs in a standard fiber. However, in FBGs, the high frequency selectivity of the grating can be used for utilizing the frequency changes in order to change in the propagation direction of the optical pulses.

It one aspect the present invention relates to an optical router for all-optical control over the propagation direction of optical pulses, comprising:

(i) a non-uniform one-dimensional photonic crystal receiving a plurality of input optical pulses, comprising: a first region used to obtain Bragg solitons; a second region used to slow down propagating Bragg solitons and to obtain non-linear interaction between two sufficiently adjacent solitons; and a third region used to de-couple the transmitted Bragg soliton outside the one-dimensional photonic crystal's grating;

(ii) a plurality of sufficiently temporally separated optical pulses launched towards said one-dimensional photonic crystal from either of its sides, such that the number of pulses de-coupled from at least one of the sides of the grating is different in case when interaction between the pulses occurs inside the grating, from the case when no interaction between pulse occurs inside the grating.

In one embodiment of the present invention, the plurality of sufficiently temporally separated optical pulses are launched towards said one-dimensional photonic crystal from one of its sides, such that a single pulse that is launched into the said one-dimensional photonic crystal is back-reflected while when two sufficiently temporally separated and sufficiently temporally adjacent optical pulses are launched into the said one-dimensional photonic crystal from the same side, interaction between two formed Bragg solitons makes one of the pulses to be transmitted through the said photonic crystal to the other side, while the other pulse is back-reflected

Sufficiently adjacent optical pulses are considered to be within 2 to 10 full-width half-maximum (FWHM).

In another embodiment of the present invention, said optical router is an AND logical gate accepting two input signals (gap solitons as “ONE” none as “ZERO”) and outputting a positive result (“ONE” i.e. gap soliton) though the grating only if two gap solitons entered the switch.

In yet another embodiment of the present invention, optical pulses indicate logic bits, and the routing device operates as an AND logical gate, for which two input bits are indicated by the presence of the optical pulses launched into the said photonic crystal and the output bit is indicated by the presence of the transmitted pulse.

In yet another embodiment of the present invention, the optical router is made such that a plurality of synchronized, counter-propagating optical pulses are launched towards said one-dimensional photonic crystal from its two opposite sides, such that a single pulse that is launched into the said one-dimensional photonic crystal is transmitted to the other side of the said photonic crystal, while when in addition to the said pulse, a second, synchronized pulse is launched from the opposite sides of the photonic crystal interaction between the two pulses causes one of the pulses to be trapped inside the said second region and the other pulse to be transmitted, so that none of the pulses is transmitted to the side to which the single pulse was transmitted.

In a further embodiment of the present invention, optical pulses indicate logic bits, and the routing device operates as an NOT logical gate, for which: one of counter propagating synchronized pulses indicates a signal bit, the other pulse indicates a clock or control bit, and the output bit is indicated by the presence of optical pulse exiting the said device from the side towards which the signal bit was launched.

In yet a further embodiment of the present invention, the one-dimensional photonic crystal is a fiber Bragg grating (FBG); Multilayer films; a quasi-periodic structure of the refractive index implemented in chalcogenide-based planar waveguides; or a quasi-periodic structure of the refractive index implemented in Erbium doped fiber.

In yet another embodiment of the present invention, the non-uniform one-dimensional photonic crystal comprises a first appodization section, in which the modulation amplitude of the grating is monotonically increasing along the photonic crystal for efficient coupling of light into the grating.

In yet a further embodiment of the present invention, the non-uniform one-dimensional photonic crystal comprises a chirped section of a finite length, in which the grating period is monotonically decreasing along the photonic crystal in case of optical material with positive non-linearity, or monotonically increasing along the photonic crystal in case of optical material with negative non-linearity.

In yet another embodiment of the present invention, the non-uniform one-dimensional photonic crystal comprises an appodized section, in which the modulation amplitude of the grating is increasing along the photonic crystal.

In yet a further embodiment of the present invention, the non-uniform one-dimensional photonic crystal further comprises another appodization section for efficient light de-coupling from the grating, in which the modulation amplitude of the grating is decreasing along the photonic crystal.

In yet another embodiment of the present invention, the grating is fabricated inside Erbium doped fiber to overcome losses in the grating, in which case the grating is pumped by pumping laser.

In yet a further embodiment of the present invention, measuring the output pulse characteristics at the output of the grating is performed by a measuring device comprising an optical sensor that translates photons flux into electric current, and an I/O unit that allows one to observe the measured electric current as a function of time or as an averaged electric current.

In another aspect the present invention relates to an optical router for all-optical control over the propagation direction of optical pulses, comprising:

(i) a non-uniform one-dimensional photonic crystal receiving a plurality of input optical pulses, comprising a first, a second and a third regions, wherein: a first and a third regions are used to obtain Bragg solitons from counter-propagating optical pulses launched from the two different sides of the said photonic crystal and slow them down; a second region used to obtain non-linear interaction between the two counter-propagating solitons;

(ii) a plurality of synchronized, counter-propagating optical pulses launched towards said one-dimensional photonic crystal from its two opposite sides;

such that a single pulse that is launched into the said one-dimensional photonic crystal is transmitted to the other side of the said photonic crystal, while when in addition to the said pulse, a second, synchronized pulse is launched from the opposite sides of the grating, interaction between the two pulses causes one of the pulses to be trapped inside the said second region and the other pulse to be transmitted, so that none of the pulses is transmitted to the side to which the single pulse was transmitted.

In another embodiment of the present invention, said router device is a NOT logical gate accepting a single input signal (gap soliton as “ONE” none as “ZERO”) and outputting a positive result (“ONE” i.e. gap soliton) though the grating only if a gap soliton entered the switch. In the NOT logical gate two solitons are launched from opposite sides of the switch. One of the solitons is the signal while the other soliton is the control soliton or the clock.

In yet another embodiment of the present invention, optical pulses indicate logic bits, and the routing device operates as an NOT logical gate, for which: one of the counter propagating synchronized pulses indicates a signal bit, the other pulse indicates a clock or control bit, and the output bit is indicated by the presence of optical pulse exiting the said device from the side towards which the signal bit was launched.

In a further embodiment of the present inventions, the one-dimensional photonic crystal is a fiber Bragg grating (FBG), Multilayer films, a quasi-periodic structure of the refractive index (i.e. grating) implemented in chalcogenide-based planar waveguides or a quasi-periodic structure of the refractive index (i.e. grating) implemented in Erbium doped fiber.

In yet a further embodiment of the present invention, the FBG is a chirped FBG or an appodized FBG.

The measured characteristics of the output pulse are typically intensity and/or energy though other characteristics, such as spectral characteristics can also be measured.

In yet another embodiment of the present inventions, the measured characteristics of the output pulse are intensity or energy or both.

In yet another embodiment of the present inventions, the non-uniform one-dimensional photonic crystal comprises a chirped section of a finite length, in which the grating period is monotonically decreasing along the fiber in case of material with positive non-linearity, and is monotonically increasing along the fiber in case of material with negative non-linearity.

In yet another embodiment of the present inventions, the non-uniform one-dimensional photonic crystal comprises an appodized section, in which the modulation amplitude of the grating is increasing along the fiber.

In yet another embodiment of the present inventions, the non-uniform one-dimensional photonic crystal further comprises a second appodization section for efficient light de-coupling from the grating, in which the modulation amplitude of the grating is decreasing along the fiber.

In a further embodiment of the present inventions, the grating is fabricated inside Erbium doped fiber to overcome losses in the grating, in which case the grating is pumped by pumping laser.

In yet another aspect, the present invention relates to a method of controlling the optical pulse propagation direction of optical pulses, comprising the steps of:

(i) receiving a plurality of input optical pulses by a non-uniform one-dimensional photonic crystal, comprising: at least one first region used to obtain Bragg solitons; at least one second region in which non-linear interaction between two sufficiently adjacent solitons is obtained; and at least one third region used to de-couple resulting after the interaction pulses outside the one-dimensional photonic crystal's grating; and

(ii) launching a plurality of sufficiently temporally separated optical pulses towards said one-dimensional photonic crystal from either of its sides, such that the number of pulses de-coupled from at least one of the sides of the grating is different in case when interaction between the pulses occurs inside the grating, from the case when no interaction between pulse occurs inside the grating.

In one embodiment of the present invention, a plurality of sufficiently temporally separated optical pulses are launched towards said one-dimensional photonic crystal from one of its sides, such that a single pulse that is launched into the said one-dimensional photonic crystal is back-reflected while when two sufficiently temporally separated and sufficiently temporally adjacent optical pulses are launched into the said one-dimensional photonic crystal from the same side, interaction between two formed Bragg solitons makes one of the pulses to be transmitted through the said photonic crystal to the other side, while the other pulse is back-reflected.

In another embodiment of the present invention, the one-dimensional photonic crystal is a non-uniform fiber Bragg grating (FBG), Multilayer films, a quasi-periodic structure of the refractive index implemented in chalcogenide-based planar waveguides or a quasi-periodic structure of the refractive index implemented in Erbium doped fiber.

In a further embodiment of the present invention, the non-uniform photonic crystal is a chirped one or an appodized one.

In yet another embodiment of the present invention, the non-uniform one-dimensional photonic crystal comprises a first appodization section, in which the modulation amplitude of the grating is monotonically increasing towards the center of the photonic crystal for efficient coupling of light into the grating.

In yet a further embodiment of the present invention, the non-uniform one-dimensional photonic crystal comprises a chirped section of a finite length, in which the grating period is monotonically decreasing along the photonic crystal in case of optical material with positive non-linearity, or monotonically increasing towards the center of the photonic crystal in case of optical material with negative non-linearity.

In yet another embodiment of the present invention, the non-uniform one-dimensional photonic crystal comprises an appodized section, in which the modulation amplitude of the grating is increasing towards the center of the photonic crystal.

In yet a further embodiment of the present invention, the non-uniform one-dimensional photonic crystal further comprises another appodization section for efficient light de-coupling from the grating, in which the modulation amplitude of the grating is decreasing away from the center of the photonic crystal.

In yet another embodiment of the present invention, the grating is fabricated inside Erbium doped fiber to overcome losses in the grating, in which case the grating is pumped by pumping laser.

In yet a further embodiment of the present invention, measuring the output pulse characteristics at the output of the grating is performed by a measuring device comprising an optical sensor that translates photons flux into electric current, and an I/O unit that allows one to observe the measured electric current as a function of time or as an averaged electric current.

In yet another embodiment of the present invention, a plurality of synchronized, counter-propagating optical pulses are launched towards said one-dimensional photonic crystal from its two opposite sides, such that a single pulse that is launched into the said one-dimensional photonic crystal is transmitted to the other side of the said photonic crystal, while when in addition to the said pulse, a second, synchronized pulse is launched from the opposite sides of the photonic crystal interaction between the two pulses causes one of the pulses to be trapped inside the said second region and the other pulse to be transmitted, so that none of the pulses is transmitted to the side to which the single pulse was transmitted.

In yet a further embodiment of the present invention, the non-uniform one-dimensional photonic crystal comprises a first and last appodization sections, in which the modulation amplitude of the grating is monotonically increasing towards the center of the photonic crystal for efficient coupling of light into the grating from both sides.

In yet another embodiment of the present invention, the non-uniform one-dimensional photonic crystal comprises first and last chirped sections of a finite length, in which the grating period is monotonically decreasing towards the center of the photonic crystal in case of optical material with positive non-linearity, or monotonically increasing towards the center of the photonic crystal in case of optical material with negative non-linearity.

In yet a further embodiment of the present invention, non-uniform one-dimensional photonic crystal comprises first and last appodized section, in which the modulation amplitude of the grating is increasing towards the center of the photonic crystal.

In yet another embodiment of the present invention, the non-uniform one-dimensional photonic crystal comprises a central section in which in which the grating period is decreased comparing to the neighboring sections of the photonic crystal in case of optical material with positive non-linearity, or increased comparing to the neighboring sections of the photonic crystal in case of optical material with negative non-linearity, for increased interaction time between the pulses.

In yet a further embodiment of the present invention, the non-uniform one-dimensional photonic crystal comprises a central section in which the modulation amplitude is lower than in the neighboring sections, for increased interaction time between the pulses.

In yet another embodiment of the present invention, measuring the transmitted or reflected pulses characteristics at the terminals of the grating is performed by a measuring device comprising an optical sensor that translates photons flux into electric current, and an I/O unit that allows one to observe the measured electric current as a function of time or as an averaged electric current.

In yet a further embodiment of the present invention, the measured characteristics of the output pulse are intensity or energy or both.

### BRIEF DESCRIPTION OF DRAWINGS

FIGS. 1A, 1B illustrate logical gate operations showing an AND gate in FIG. 1A and a NOT gate in FIG. 1B. The arrows represent the propagation directions of optical pulses in the fiber. The vertical lines arrays represent FBG.

FIGS. 2A, 2B show the structure of the chirped FBGs used showing an AND gate in FIG. 2A and a NOT gate in FIG. 2B.

FIGS. 3A, 3B show simulation results showing the intensity I of the wave propagating in the device when a single soliton is launched (FIG. 3A); and two solitons are launched (FIG. 3B). The relative phase and the delay between the solitons are equal to 5.1 radian and 94 ps, respectively. The 2D plots give an upper view on the solitons trajectories. The straight lines mark the different regions of the grating.

FIGS. 4A, 4B show simulation results showing the intensity I of the waves propagating in the NOT gate when (FIG. 4A) a single soliton is launched, (FIG. 4B) two solitons are launched. The pulses in (FIG. 4B) were launched simultaneously from the opposite sides of the gate. The relative phase between the input solitons at the gate inputs was 4.3 radians. The 2D plots give an upper view on the solitons trajectories. The straight lines mark the different regions of the grating.

FIG. 5 shows a central frequency shift of the solitons Δf as a function of the location when a single soliton is launched (solid line) and when two solitons are launched (dashed and dashed-dotted lines, which correspond to the trailing and the forward solitons, respectively). The vertical lines mark the different regions of the grating.

FIG. 6 shows simulation results showing the wave propagation in the device when two solitons are launched with a relative phase of π+5.1.

### DESCRIPTION OF EMBODIMENTS

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

Interaction between Bragg solitons with the same polarization changes the frequencies of the interacting solitons. Similar effect occurs in a standard fiber [11]. However, in FBGs, the high frequency selectivity of the grating can be used for utilizing the frequency changes in order to obtain logical operators. The lengths of the proposed devices can be about 15 cm, two orders of magnitude shorter then soliton-based optical devices in regular fibers [1]. The maximum power needed to operate the devices can be on the order of hundreds of watts. The gates can be cascaded in order to obtain complicated logical operators. The proposed devices operation is not sensitive to the phases of the input solitons.

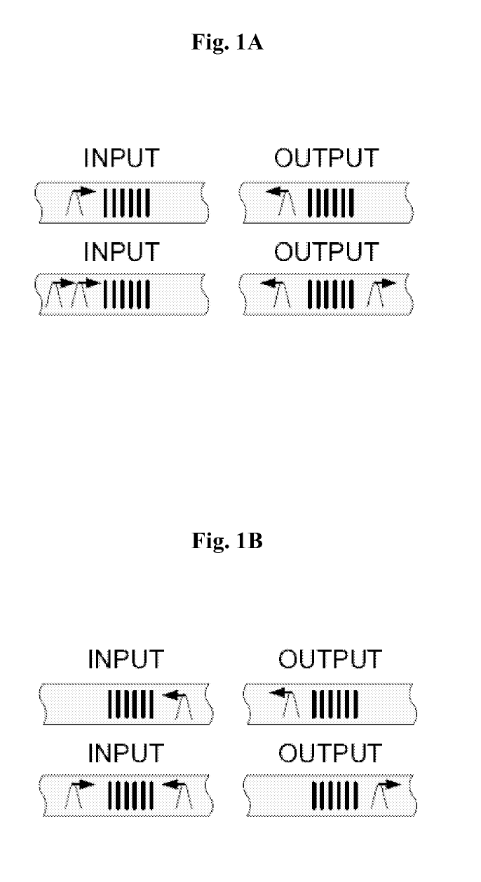

FIGS. 1A and 1B illustrate the device operation for the AND gate (FIG. 1A) and the NOT gate (FIG. 1B). The arrows represent the propagation directions of optical pulses in the fiber. The vertical lines arrays represent FBG. A “ONE” state is determined by the presence of a soliton. For the AND gate, the input solitons are launched from the same side. When a single soliton is launched into the device, it is back-reflected. However, when two solitons with approximately the same parameters are launched, one of the solitons is transmitted while the other soliton is back-reflected. Therefore, a “ONE” state, represented by the transmitted soliton, is obtained only when two solitons are launched. Unlike the device reported in Refs. [5], [6], the device of the invention operates with solitons that have the same polarization and hence it does not require using polarizers. The device of the invention is based on a soliton interaction that increases the frequency of one of the solitons and hence enables its transmission through the grating bandgap. This effect does not require that the input solitons will be launched at the same time, as needed in former works in order to strongly shift the bandgap frequency. [5], [6] Therefore, an AND operation is obtained even when the two solitons remain well separated along the whole device.

In case of the NOT gate, two solitons are launched from opposite sides of the device. One of the solitons is the signal while the other soliton is the control soliton or the clock. The output signal is defined by the existence of pulse that exits the grating side, where the signal soliton was launched. Therefore, the input and the output signals propagate in opposite directions. When the clock soliton is launched without the signal soliton, the clock is transmitted through the device and hence a “ONE” state is obtained. When two solitons are launched, no wave exits at the grating side where the signal was launched and hence a “ZERO” state is obtained.

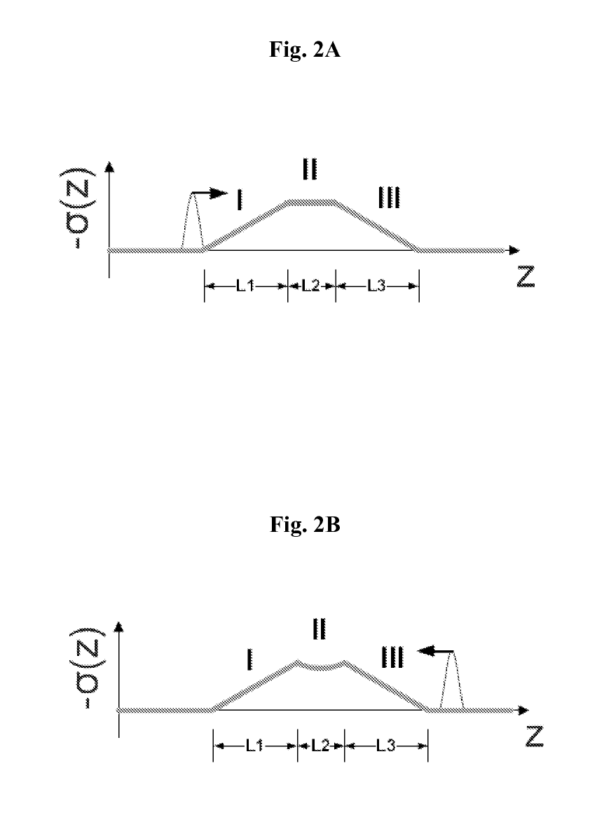

The AND gate, made of a chirped FBG, is divided into three regions as shown in FIG. 2A. In region (I), the chirp of the grating is used to slow-down the soliton velocity. [8] When a single soliton enters the device it is back-reflected. When two solitons are launched, the spatial distance between the solitons decreases and a strong interaction is obtained in region (I). The frequency of one of the solitons is increased above Bragg region of the grating and hence it overcome the bandgap and is able to be transmitted through the device. The frequency of the other soliton is decreased and hence it is back-reflected. Region (III) is used to obtain an output soliton with parameters similar to those of the input soliton. The chirp in this region has the same magnitude but has an opposite sign compared to that in region (I). Simulations show that there is a need to add another uniform grating region II, in order to stabilize the transmitted soliton.

The NOT gate is a chirped FBG divided into three sections, as shown in FIG. 2B. The signal and the clock pulses are slowed down in regions I and III, respectively. The chirp in these regions is designed to allow the transmission of the clock soliton when the signal soliton is not launched. When the two pulses are simultaneously launched, a strong interaction is obtained in region II because of the slow velocities of the counter-propagating pulses in this region.

In order to increase the duration of the soliton interaction, the shape of the chirp in region II is designed to form an effective potential well for the solitons. In order to break the symmetry of the device for the two pulses, the frequency of the signal soliton is chosen to be slightly higher then the frequency of the clock soliton. Due to the interaction, the frequency of the clock soliton is decreased. Therefore, when both of the solitons are launched, the signal soliton is transmitted through the device while the clock soliton is trapped inside region II and will be eventually absorbed and smeared.

The propagation of pulses inside a FBG can be analyzed using the coupled-mode equations [3]:

±i∂_{z}u_{±}+iV_{g}⁻¹∂ₙu_{±}+κu_{∓}+Γ(|u_{±}|²+2|u_{∓}|²)u_{±}+σ(z)u_{±}=0, (1)

where u± is the slowly varying amplitude of the forward (+) and the backward (−) propagating waves, σ(z) is the chirp parameter, κ is the grating amplitude, Γ is the non-linear coefficient, V_{g}=c/n_{eff} is the fiber group velocity, and n_{eff}=1.45 is the effective refractive index. We solve the coupled-mode equations using the method described in Ref. [9]. The lengths of the grating regions for the AND gate, are L₁=L₃=5:11 cm, L₂=2:34 cm, and hence the total grating length is equal to 12.55 cm. In the case of the NOT gate, the lengths of the grating regions are L₁=L₃=5.03 cm, L₂=2.34 cm, and hence the total grating length is equal to 12.39 cm. The grating parameters in both cases are: κ=9000 m⁻¹ and σ(z), is a linear function of z in regions I and III with a slope of −888.594 and +888.594 m⁻² respectively. In case of the AND gate σ≡−45:41 m⁻¹ in region II. In case of the NOT gate σ(z) in region II has a full-period cosine profile with a minimum value of −44.7 m⁻¹ at both ends of region II and a maximum value of −40.7 m⁻¹ at the middle of region II. In order to demonstrate the absorption and the smearing of the trapped soliton, we assume that the fiber loss coefficient is equal to α=0.023 m⁻¹.

The input solitons had a full width at half maximum (FWHM) of 18.85 ps and a peak power of 3.02 kW. The frequency offset of the input solitons for the AND gate and for the clock soliton of the NOT gate, relative to the local Bragg frequency at the grating entrance, was equal to 297.48 GHz. The frequency offset of the signal soliton in the NOT gate was equal to 297.53 GHz. Hence all of the input solitons were located outside the grating bandgap. By using the method described in Ref. [7], the required input solitons can be formed from input pulses with a peak power of only 340 W and a FWHM of 640 ps.

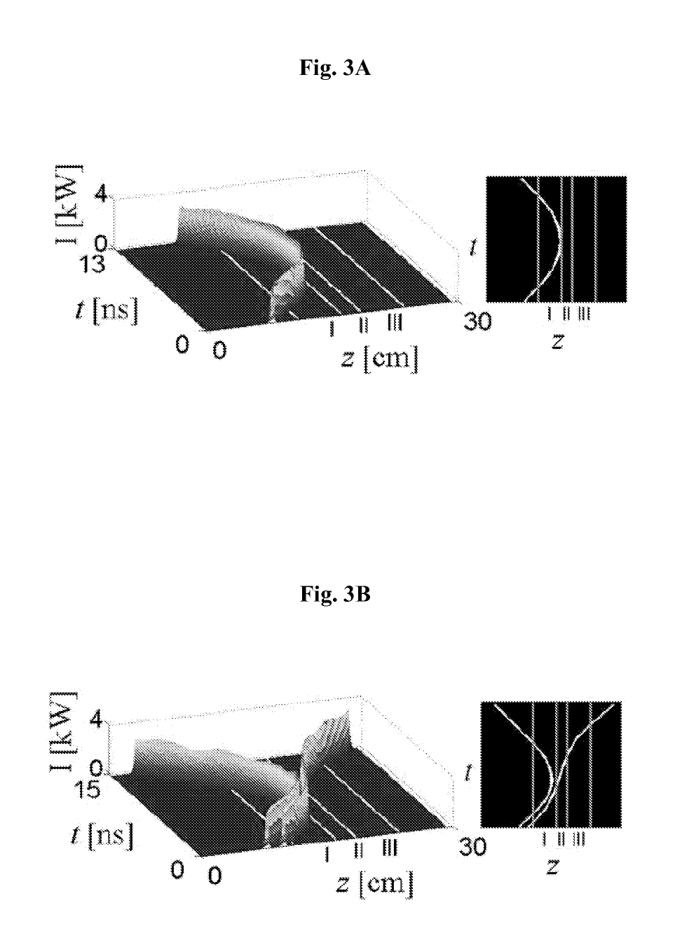

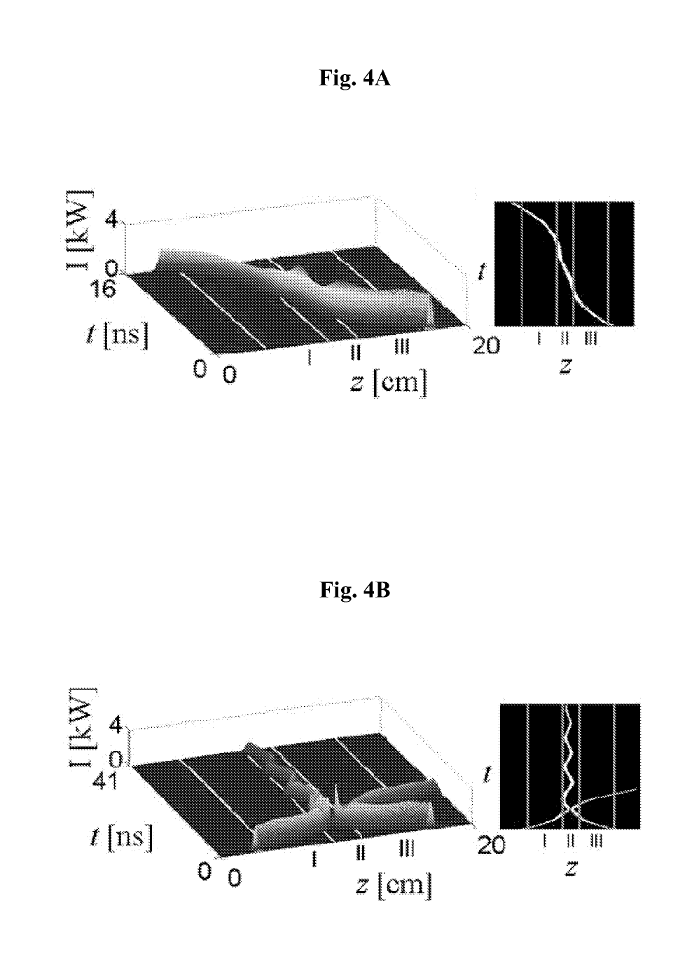

The results of the simulations, shown in FIGS. 3A, 3B and FIGS. 4A, 4B, demonstrate the operation of the two gates as described above. FIGS. 3A, 3B also show that the output pulses may experience oscillations. However, we have verified that the amplitude oscillation does not prevent cascading of two AND gates.

The minimal spatial separation between the peaks of the two solitons during the interaction, shown in FIG. 3B, was about 1 cm while the FWHM of the input solitons was equal to 0.39 cm. Therefore, we could study separately the frequency change of each soliton during the interaction. The results showed that the frequency of the forward propagating soliton at the entrance to region II was about 0.2 GHz higher when two solitons were launched, compared to the case when only a single soliton was launched. We have verified that the increase in the forward soliton frequency enabled its transmission through region II of the grating. The energy Q and the normalized velocity \tilde{ν} of the pulses can be calculated using the moments:

$$\begin{matrix}Q ≡ {\int }_{- ∞}^{+ ∞} ( {\vert {u}_{+} \vert}^{2} + {\vert {u}_{-} \vert}^{2} ) d z , & ( 2 ) \\ \tilde{v} ≡ {Q}^{- 1} {\int }_{- ∞}^{+ ∞} ( {\vert {u}_{+} \vert}^{2} - {\vert {u}_{-} \vert}^{2} ) d z . & ( 3 )\end{matrix}$$

The integration was performed for each pulse separately over a spatial window that was equal to about 3.5 of the spatial FWHM of the input solitons. We have verified that during the interaction the two pulses maintained their hyperbolic-secant profiles. Therefore, we used the connections for solitons: [8]

$$Q = \frac{2 \tilde{δ}}{Γ} {( 1 + \frac{1}{2} \frac{1 + {v}^{2}}{1 - {v}^{2}} )}^{- 1} , \qquad ( 4 )$$

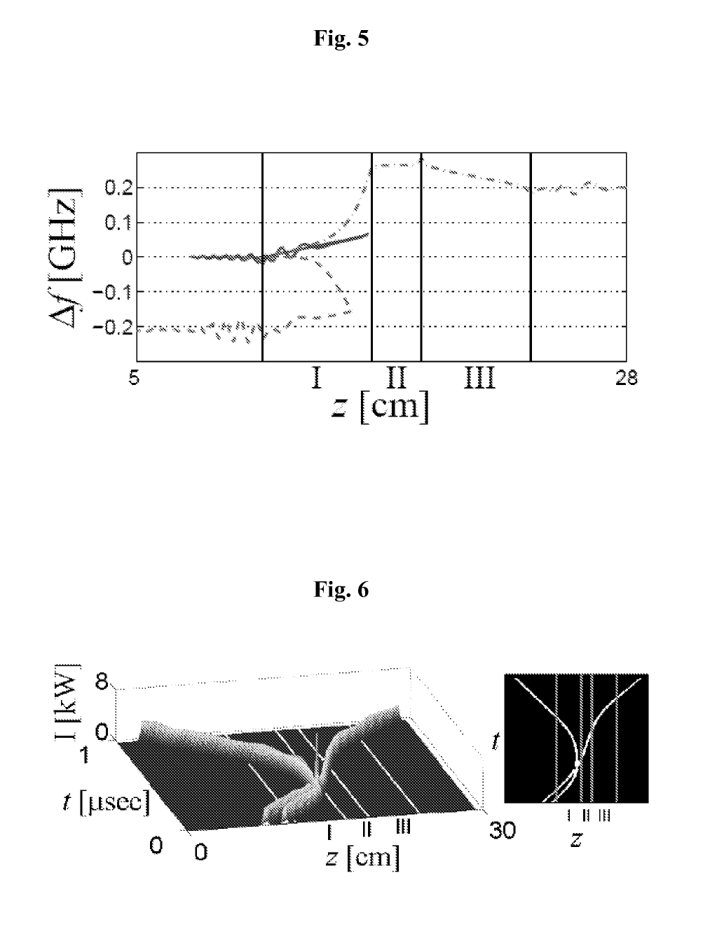

and ν=\tilde{ν}, where (\tilde{δ}, ν) are the soliton parameters as defined in Ref. 3. The frequency shift of the soliton relative to the local Bragg frequency is given by Ω=(1−ν²)^{-0.5}κcos(\tilde{δ})V_{g}. [3] The absolute shift in the soliton carrier frequency is equal to Δf=Ω−σ(z)V_{g}−Ω₀, where Ω₀ is the initial detuning of the soliton relative to the local Bragg frequency. The frequency shift as a function of the solitons location when a single soliton is launched and when two solitons are launched is shown in FIG. 5.

FIG. 5 shows that the interaction between the solitons changes their frequencies. During the interaction the frequency of forward soliton at the entrance to region (II) is about 0.2 GHz higher when two solitons are launched, compared to the case when only a single soliton is launched. The increase in the forward soliton frequency enables its transmission through region (II) of the grating. To verify that the change of 0.2 GHz in the soliton frequency can transmit the forward soliton through the grating, we have simulated the propagation of a single soliton through the grating for several different initial central frequencies. We have found out that when the initial central frequency of the soliton, shown in FIG. 3A, was increased by more than 0.05 GHz, the soliton was transmitted through the grating.

The interaction depends on the relative phase between the two solitons. FIG. 6 shows the interaction when the relative phase was increased by π compared to the case shown in FIG. 3B. Depending on the relative phase, the interference between the solitons may increase or decrease the intensity in the spatial region between the pulses. Hence, the bandgap in that region may be shifted towards or shifted away from the solitons carrier frequency due to Kerr effect. In the first case the solitons experience a repulsive force. Therefore, the frequency and the velocity increase for the forward soliton and decrease for the trailing soliton. Hence, the two solitons remain separated as shown in FIG. 3B. In the second case, the solitons attract each other. Hence, the frequency and the velocity decrease for the forward soliton and increase for the trailing soliton. Therefore, the two solitons overlap on time during the interaction and the trailing soliton is transmitted through the grating, as shown in FIG. 6. We have simulated the device behavior for different relative phases between the input solitons, that were uniformly distributed in the region [0, 2π]. We have found that although the waveforms evolved differently during the interaction, a single soliton was back-reflected, while when two solitons were launched, one of the solitons was transmitted.

The carrier frequency of the input solitons could be changed in the region [−150, 50] MHz compared to the carrier frequency used in FIGS. 3A and 3B. When two gates are cascaded, the bandgap of the second gate should be slightly up-shifted compared to that of the first gate in order to take into account the frequency change of the soliton transmitted from the first gate. The above analysis indicated that if the soliton frequency is increased only slightly the transmission of the AND gate becomes very strong. Alternatively, if the grating pitch is changed by an extremely small amount (tenths of pico-meter in the above described setup), the grating transmissivity can be dramatically changed. The grating pitch change can be induced by various physical changes in the environment of the fiber, such as physical strain, temperature change, humidity change (effectively, through the propagating mode propagation constant) etc. Accordingly, the described device can sense extremely small changes in the environment and translate these changes into drastic changes in the transmission intensity. The typical measurement setup to detect such changes would include a grating similar to that introduced above, a pulsed, stable laser source that would generate pulses train for repetitive launching of Bragg solitons at a sufficiently stable frequency and a detector on the transmission side of the grating. The laser frequency and the grating pitch can be tuned one towards the other, both by using laser frequency tuning and the grating strain tuning by some piezoelectric element. The grating should be put in such way, so that the physical force under the measurement would apply on it. The detector would measure the optical intensity at the output of the grating. When the applied physical force becomes lower or higher of some threshold value, a drastic change in grating transmission would be detected by the sensor.

σ(z) is proportional to the changes in the average refractive index along a single period of the grating. A similar effect of the grating on the soliton propagating can be obtained if instead of decreasing and increasing the average refractive index along sections I and III respectively, the local grating pitch is decreased in section I and increased in section III, assuming the case of positive non-linearity Γ>0. Another option is to keep the average refractive index and the grating pitch constant along the grating, only changing the modulation depth of the grating, increasing it along section I, and decreasing it along section III (appodization).

The above gate and sensor rely on propagation of slow Bragg solitons. Since the losses in FBGs are much higher then the losses in untreated fiber, the slowly propagating Bragg solitons can experience a sufficient attenuation while propagating through the grating. Due to the losses the propagating soliton can break and couple to dispersive waves. Accordingly, we propose a method to overcome the attenuation of slow Bragg solitons in the above mentioned gate and sensor and also for other applications not described here. The idea is to write the FBG for Bragg solitons propagation into an Erbium doped fiber, similarly to the distributed feedback (DFB) lasers. Here, however, our interest is not to use the grating as a laser amplifying cavity, but only to achieve a sufficient distributed gain to overcome the losses. As a result we do not restrict ourselves to phase-shifted gratings and to optical frequencies well inside the bandgap.

Soliton interaction depends on the relative phase between the interacting solitons. We have simulated the behavior of the AND and the NOT gates for 10 different initial relative phases between the solitons, uniformly distributed in the region [0, 2π]. We have found that although the waveforms evolved differently during the interaction, correct operation of the gates was maintained.

FIGS. 3A and 3B also show that the transmitted and the back-reflected pulses experience oscillations in their amplitude as was observed in previous work [8].

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

### REFERENCES

1. Kyu H. Ahn, M. Vaziri, Brandon C. Barnett, Guy R. Williams, X. D. Cao, Mohammed N. Islam, B. Malo, Kenneth O. Hill, and D. Q. Chowdhury, J. Lightwave Technol., 14, 8 (1996)
2. C. R. Menyuk, Opt. Lett., 12, 614 (1987); J. Opt. Soc. Am. B 12, 392 (1988).
3. C. M. de Sterke and J. E. Sipe, “Gap Solitons”, in Progress in Optics XXXIII, E. Wolf ed., (Elsevier, Amsterdam, 1994), pp. 203-260
4. N. G. R. Broderick, D. J. Richardson, and M. Ibsen, Opt. Lett., 25, 536 (2000).
5. D. Taverner, N. G. R. Broderick, D. J. Richardson, M. Ibsen, and R. I. Laming, Opt. Lett., 23, 259 (1998).
6. S. Pereira and J. E. Sipe, Opt. Exp., 3, 418 (1998).
7. A. Rosenthal and M. Horowitz, Phys. Rev. E, 74, 066611 (2006).
8. N. G. R. Broderick and C. M. de Sterke, Phys. Rev. E, 51, 4978 (1995); Phys. Rev. E, 58, 7941 (1998).
9. A. Rosenthal and M. Horowitz, Opt. Lett., 31, 1334 (2006).
10. J. T. Mok, C. M. de Sterke, I. C. M. Littler and B. J. Eggleton, Nature Phys. 2, 775 (2006).
11. P. V. Mamyshev and L. F. Mollenauer, Opt. Lett., 24, 448 (1999).

1. An optical router for all-optical control over the propagation direction of optical pulses, comprising:
(i) a non-uniform one-dimensional photonic crystal receiving a plurality of input optical pulses, comprising: at least one first region used to obtain Bragg solitons; at least one second region in which non-linear interaction between two sufficiently adjacent solitons is obtained; and at least one third region used to de-couple resulting after the interaction pulses outside the one-dimensional photonic crystal's grating; and
(ii) a plurality of sufficiently temporally separated optical pulses launched towards said one-dimensional photonic crystal from either of its sides, such that the number of pulses de-coupled from at least one of the sides of the grating is different in case when interaction between the pulses occurs inside the grating, from the case when no interaction between pulse occurs inside the grating.

2. An optical router according to claim 1, wherein said plurality of sufficiently temporally separated optical pulses are launched towards said one-dimensional photonic crystal from one of its sides, such that a single pulse that is launched into the said one-dimensional photonic crystal is back-reflected while when two sufficiently temporally separated and sufficiently temporally adjacent optical pulses are launched into the said one-dimensional photonic crystal from the same side, interaction between two formed Bragg solitons makes one of the pulses to be transmitted through the said photonic crystal to the other side, while the other pulse is back-reflected.

3. An optical router according to claim 1, wherein optical pulses indicate logic bits, and the routing device operates as an AND logical gate, for which two input bits are indicated by the presence of the optical pulses launched into the said photonic crystal and the output bit is indicated by the presence of the transmitted pulse.

4. An optical router according to claim 1, wherein a plurality of synchronized, counter-propagating optical pulses are launched towards said one-dimensional photonic crystal from its two opposite sides, such that a single pulse that is launched into the said one-dimensional photonic crystal is transmitted to the other side of the said photonic crystal, while when in addition to the said pulse, a second, synchronized pulse is launched from the opposite sides of the photonic crystal interaction between the two pulses causes one of the pulses to be trapped inside the said second region and the other pulse to be transmitted, so that none of the pulses is transmitted to the side to which the single pulse was transmitted.

5. An optical router according to claim 4, wherein optical pulses indicate logic bits, and the routing device operates as an NOT logical gate, for which: one of counter propagating synchronized pulses indicates a signal bit, the other pulse indicates a clock or control bit, and the output bit is indicated by the presence of optical pulse exiting the said device from the side towards which the signal bit was launched.

6. An optical router according to claim 1, wherein said one-dimensional photonic crystal is a fiber Bragg grating (FBG); Multilayer films; a quasi-periodic structure of the refractive index implemented in chalcogenide-based planar waveguides; or a quasi-periodic structure of the refractive index implemented in Erbium doped fiber.

7. An optical router according to claim 6, wherein said FBG is a chirped FBG or an appodized FBG.

8. An optical router according to claim 1, wherein the measured characteristics of the output pulse are intensity or energy or both.

9. An optical router according to claim 1, wherein said non-uniform one-dimensional photonic crystal comprises a first appodization section, in which the modulation amplitude of the grating is monotonically increasing along the photonic crystal for efficient coupling of light into the grating.

10. An optical router according to claim 1, wherein said non-uniform one-dimensional photonic crystal comprises a chirped section of a finite length, in which the grating period is monotonically decreasing along the photonic crystal in case of optical material with positive non-linearity, or monotonically increasing along the photonic crystal in case of optical material with negative non-linearity.

11. An optical router according to claim 1, wherein said non-uniform one-dimensional photonic crystal comprises an appodized section, in which the modulation amplitude of the grating is increasing along the photonic crystal.

12. An optical router according to claim 1, wherein said non-uniform one-dimensional photonic crystal further comprises another appodization section for efficient light de-coupling from the grating, in which the modulation amplitude of the grating is decreasing along the photonic crystal.

13. An optical router according to claim 1, wherein the grating is fabricated inside Erbium doped fiber to overcome losses in the grating, in which case the grating is pumped by pumping laser.

14. An optical router according to claim 1, wherein measuring the output pulse characteristics at the output of the grating is performed by a measuring device comprising an optical sensor that translates photons flux into electric current, and an I/O unit that allows one to observe the measured electric current as a function of time or as an averaged electric current.

15. A method of controlling the optical pulse propagation direction of optical pulses, comprising the steps of:
(i) receiving a plurality of input optical pulses by a non-uniform one-dimensional photonic crystal, comprising: at least one first region used to obtain Bragg solitons; at least one second region in which non-linear interaction between two sufficiently adjacent solitons is obtained; and at least one third region used to de-couple resulting after the interaction pulses outside the one-dimensional photonic crystal's grating; and
(ii) launching a plurality of sufficiently temporally separated optical pulses towards said one-dimensional photonic crystal from either of its sides, such that the number of pulses de-coupled from at least one of the sides of the grating is different in case when interaction between the pulses occurs inside the grating, from the case when no interaction between pulse occurs inside the grating.

16. A method according to claim 15, wherein a plurality of sufficiently temporally separated optical pulses are launched towards said one-dimensional photonic crystal from one of its sides, such that a single pulse that is launched into the said one-dimensional photonic crystal is back-reflected while when two sufficiently temporally separated and sufficiently temporally adjacent optical pulses are launched into the said one-dimensional photonic crystal from the same side, interaction between two formed Bragg solitons makes one of the pulses to be transmitted through the said photonic crystal to the other side, while the other pulse is back-reflected.

17. A method according to claim 15, wherein said one-dimensional photonic crystal is a non-uniform fiber Bragg grating (FBG), Multilayer films, a quasi-periodic structure of the refractive index implemented in chalcogenide-based planar waveguides or a quasi-periodic structure of the refractive index implemented in Erbium doped fiber.

18. A method according to claim 15, wherein said non-uniform photonic crystal is a chirped one or an appodized one.

19. A method according to claim 18, wherein said non-uniform one-dimensional photonic crystal comprises a first appodization section, in which the modulation amplitude of the grating is monotonically increasing towards the center of the photonic crystal for efficient coupling of light into the grating.

20. A method according to claim 18, wherein said non-uniform one-dimensional photonic crystal comprises a chirped section of a finite length, in which the grating period is monotonically decreasing along the photonic crystal in case of optical material with positive non-linearity, or monotonically increasing towards the center of the photonic crystal in case of optical material with negative non-linearity.

21. A method according to claim 18, wherein said non-uniform one-dimensional photonic crystal comprises an appodized section, in which the modulation amplitude of the grating is increasing towards the center of the photonic crystal.

22. A method according to claim 18, wherein said non-uniform one-dimensional photonic crystal further comprises another appodization section for efficient light de-coupling from the grating, in which the modulation amplitude of the grating is decreasing away from the center of the photonic crystal.

23. A method according to claim 15, wherein the grating is fabricated inside Erbium doped fiber to overcome losses in the grating, in which case the grating is pumped by pumping laser.

24. A method according to claim 15, wherein measuring the output pulse characteristics at the output of the grating is performed by a measuring device comprising an optical sensor that translates photons flux into electric current, and an I/O unit that allows one to observe the measured electric current as a function of time or as an averaged electric current.

25. A method according to claim 15, wherein a plurality of synchronized, counter-propagating optical pulses are launched towards said one-dimensional photonic crystal from its two opposite sides, such that a single pulse that is launched into the said one-dimensional photonic crystal is transmitted to the other side of the said photonic crystal, while when in addition to the said pulse, a second, synchronized pulse is launched from the opposite sides of the photonic crystal interaction between the two pulses causes one of the pulses to be trapped inside the said second region and the other pulse to be transmitted, so that none of the pulses is transmitted to the side to which the single pulse was transmitted.

26. A method according to claim 25, wherein said non-uniform one-dimensional photonic crystal comprises a first and last appodization sections, in which the modulation amplitude of the grating is monotonically increasing towards the center of the photonic crystal for efficient coupling of light into the grating from both sides.

27. A method according to claim 25, wherein said non-uniform one-dimensional photonic crystal comprises first and last chirped sections of a finite length, in which the grating period is monotonically decreasing towards the center of the photonic crystal in case of optical material with positive non-linearity, or monotonically increasing towards the center of the photonic crystal in case of optical material with negative non-linearity.

28. A method according to claim 25, wherein said non-uniform one-dimensional photonic crystal comprises first and last appodized section, in which the modulation amplitude of the grating is increasing towards the center of the photonic crystal.

29. A method according to claim 25, wherein said non-uniform one-dimensional photonic crystal comprises a central section in which in which the grating period is decreased comparing to the neighboring sections of the photonic crystal in case of optical material with positive non-linearity, or increased comparing to the neighboring sections of the photonic crystal in case of optical material with negative non-linearity, for increased interaction time between the pulses.

30. A method according to claim 25, wherein said non-uniform one-dimensional photonic crystal comprises a central section in which the modulation amplitude is lower than in the neighboring sections, for increased interaction time between the pulses.

31. A method according to claim 15, wherein measuring the transmitted or reflected pulses characteristics at the terminals of the grating is performed by a measuring device comprising an optical sensor that translates photons flux into electric current, and an I/O unit that allows one to observe the measured electric current as a function of time or as an averaged electric current.

32. A method according to claim 15, wherein the measured characteristics of the output pulse are intensity or energy or both.
